(19) United States
(12) Patent Application Publication
(10) Pub. No.: US 2017/0168871 A1
(43) Pub. Date: Jun. 15, 2017

(54) METHOD AND ELECTRONIC DEVICE FOR TRIGGERING BACKGROUND TASK

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Pengtao DU, Beijing (CN)

(21) Appl. No.: 15/244,598

(22) Filed: Aug. 23, 2016

Related U.S. Application Data
(63) Continuation of application No. PCT/CN2016/088597, filed on Jul. 5, 2016.

(30) Foreign Application Priority Data
Dec. 15, 2015 (CN) 201510938110.7

(51) Int. Cl. G06F 9/48; G06F 11/30; G06F 11/34

(52) U.S. Cl. CPC G06F 9/4881; G06F 11/3409; G06F 11/3024

(57) ABSTRACT

A method for triggering a background task, including: receiving a request for performing the background task on an intelligent terminal; acquiring a current performance parameter of the intelligent terminal; and triggering to perform the background task, when determining that a condition for performing the background task is satisfied, based on the current performance parameter of the intelligent terminal.

### CROSS REFERENCE TO RELATED APPLICATIONS

This application is a continuation of a PCT application with an Application No. PCT/CN2016/088597, filed on Jul. 5, 2016, which claims priority to Chinese Patent Application No. 2015109381107, filed on Dec. 15, 2015, entitled “Method and Apparatus for Triggering Background Task”, which is incorporated herein by reference in its entirety.

### TECHNICAL FIELD

This application relates to the computer technology, for example, to a method and an electronic device for triggering a background task.

### BACKGROUND

An intelligent terminal has an independent operating system, therefore, in addition to common basic functions of a front end, such as playing videos, taking photos, surfing the Internet, the intelligent terminal also can run other background tasks in the background, such as updating the system, downloading software and detecting system security.

In the related art, some background tasks, which consume higher resources and occupy longer time, are usually activated manually by a user, or performed regularly and automatically, or performed immediately after a performing request is received from a server end. However, these performing manners will cause problems of slow reaction, stagnation, even crash due to a poor performance when the intelligent terminal performs these tasks. For example, when an intelligent terminal downloads software, if a user plays videos on the intelligent terminal simultaneously, the two tasks, i.e. playing videos and downloading software will run slowly since playing videos and downloading software both occupy greater memory resources. In conclusion, as for the intelligent terminal in the related art, its own resources are not adequately taken into account when the background tasks are run.

### SUMMARY

This application provides a method and an electronic device for triggering a background task, solving the phenomenon of stagnation, even crash of the intelligent terminal caused by running of background task, and guaranteeing smooth running of functions of front end when the terminal equipment performs the background task.

In a first aspect, embodiments of this application provide a method for triggering a background task, which includes:

receiving a request for performing the background task on an intelligent terminal;

acquiring a current performance parameter of the intelligent terminal; and

triggering to perform the background task, when determining that a condition for performing the background task is satisfied, based on the current performance parameter of the intelligent terminal.

In a second aspect, embodiments of this application also provide a non-transitory computer storage medium storing computer executable instructions, when executed by an electronic device, causes the electronic device to perform the method for triggering the background task in embodiments of this application.

In a third aspect, embodiments of this application also provide an electronic device, including: at least one processor, and a memory communicably connected with the at least one processor and for storing instructions executable by the at least one processor; wherein execution of the instructions by the at least one processor causes the at least one processor to perform any of the above-described methods for triggering the background task in this application.

### BRIEF DESCRIPTION OF DRAWINGS

One or more embodiments are illustrated with reference to pictures in the corresponding accompanying drawings, which is not intended to limit embodiments, the same reference numerals in the drawings indicate similar elements, and these drawings are not drawn to scale, unless otherwise specified.

FIG. 1 is a schematic flowchart of a method for triggering a background task according to Embodiment 1 of this application;

FIG. 2 is a schematic flowchart of a method for triggering a background task according to Embodiment 2 of this application;

FIG. 3 is a schematic flowchart of a method for triggering a background task according to Embodiment 3 of this application;

FIG. 4 is a schematic diagram showing a structure of an apparatus for triggering a background task according to Embodiment 4 of this application; and

FIG. 5 is a schematic diagram showing the structure of hardware of an electronic device for performing a method for triggering a background task according to Embodiment 7 of this application.

### DETAILED DESCRIPTION

Hereinafter, this application will be explained in more detail with reference to the accompanying drawings and embodiments. It should be understood that the embodiments described herein are only intended to be illustrative and not restrictive. It should be additionally understood that, for illustrative purposes, only those portions relevant to this application, not all the structures are shown in the accompanying drawings.

### Embodiment 1

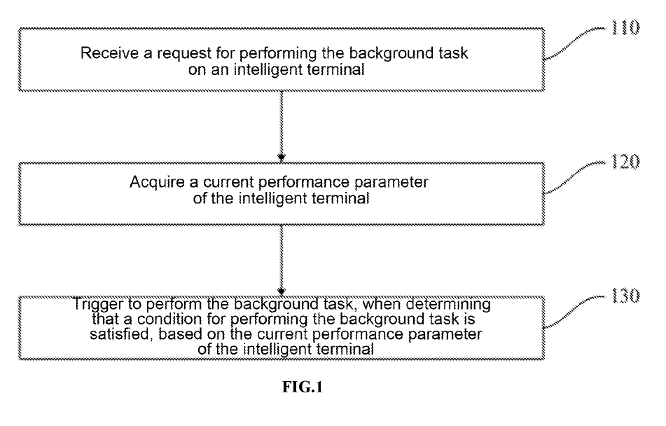

FIG. 1 is a schematic flowchart of a method for triggering a background task according to Embodiment 1 of this application, this embodiment is applicable to a case that the background task is performed in an intelligent terminal, and the method can be performed by an intelligent terminal, for example, an apparatus for triggering a background task installed on a smart phone, a tablet computer, and can include the following steps of:

Step 110, receiving a request for performing a background task on an intelligent terminal;

Particularly, receiving a request for triggering a background task can include three manners, the first one is a request for performing a background task on an intelligent terminal, transmitted by a server end, such as a request of pushing a software installation package by a server; the second one is a request for performing a background task regularly triggered by an application software on an intelligent terminal, such as a regular virus-killing request of a virus-killing software; the third one is a request for performing a background task on an intelligent terminal, initiated by a user, such as a request of downloading game installation files.

Step 120, acquiring a current performance parameter of the intelligent terminal;

Particularly, the performance parameter comprises: at least one of a CPU load, a memory occupation rate, the current charge, the current charging type and a network bandwidth parameter, wherein, the charging type consists of power charging, computer charging and a charging-free state, the network bandwidth parameter includes a connection manner of the intelligent terminal, such as wife network connection, Bluetooth connection, 2G network connection, 3G network connection, 4G network connection or network-free connection, and the remaining network bandwidth of the intelligent terminal, and etc.

Step 130, triggering to perform a background task, when determining that a condition for performing the background task is satisfied, based on the current performance parameter of the intelligent terminal;

Particularly, the condition for performing the background task can be relevant parameters required when performing the background task on the intelligent terminal, such as a CPU occupation, a memory occupation, charge usage and a network bandwidth, these parameters can be recorded in a database when the task is performed for the first time, and can be recalled from the database when performed for the next time, after the current performance parameter is acquired in step 120, whether the current performance parameter satisfies the condition for performing the background task can be judged according to the above relevant parameters. Alternatively, the above condition for performing the background task is a performance evaluation threshold of the intelligent terminal set in advance, and the above background task can be performed only after the performance evaluation threshold is reached. After the current performance parameter of the intelligent terminal is acquired in step 120, the current performance evaluation value of the intelligent terminal can be acquired based on the current performance parameter, then the current performance evaluation value of the intelligent terminal and the above performance evaluation threshold are compared, so that whether to satisfy the condition for performing the background task can be judged.

Optionally, a plurality of current performance parameters of the intelligent terminal can be acquired in step 120, then acquiring the current performance evaluation value of the intelligent terminal according to the current performance parameter of the intelligent terminal in this step can include two manners, one is to multiply each of the plurality of current performance parameters by a respective weight value corresponding to the each of the plurality of performance parameters, and average out the current performance evaluation value; the other is to determine a respective performance evaluation level of each of the plurality of current performance parameters, based on the plurality of current performance parameters, wherein, each performance evaluation level corresponds to one performance level value, and the sum of performance level values corresponding to the plurality of current performance parameters is taken as the current performance evaluation value.

By adopting the technical solution in this embodiment, when the intelligent terminal is ready to perform a background task, firstly, the current performance parameter of the intelligent terminal is acquired, and then the background task is triggered and performed when it is determined that the current state of the intelligent terminal can satisfy the condition for performing the background task, based on the current performance parameter, thereby solving the phenomenon of stagnation, even crash of the intelligent terminal caused by running of the background task, and guaranteeing smooth running of functions of front end when the terminal equipment performs the background task.

On the basis of the above technical solutions, after receiving the request for performing the background task on the intelligent terminal, it further includes a condition for performing the background task, for subsequent judgment.

### Embodiment 2

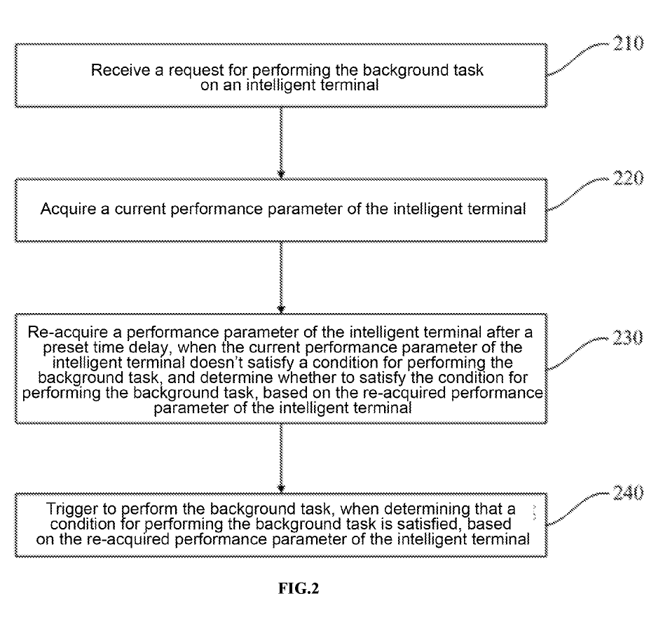

FIG. 2 is a schematic flowchart of a method for triggering a background task according to Embodiment 2 of this application, this embodiment is applicable to a case that the background task is performed in an intelligent terminal, and the method can be performed by an intelligent terminal, for example, an apparatus for triggering the background task installed on a smart phone, a tablet computer, and can include the following steps of:

Step 210, receiving a request for performing a background task on an intelligent terminal;

Step 220, acquiring a current performance parameter of the intelligent terminal;

Step 230, re-acquiring a performance parameter of the intelligent terminal after a preset time delay, when the current performance parameter of the intelligent terminal doesn't satisfy a condition for performing the background task, and determining whether to satisfy the condition for performing the background task, based on the re-acquired performance parameter of the intelligent terminal;

Particularly, the above preset time can be set to be 30 minutes, and the performance parameter of the intelligent terminal can be re-acquired after a delay of 30 minutes.

Step 240, triggering to perform the background task, when determining that a condition for performing the background task is satisfied, based on the re-acquired performance parameter of the intelligent terminal.

By adopting the technical solutions in the embodiments of this application, when the intelligent terminal is ready to perform the background task, firstly, the current performance parameter of the intelligent terminal is acquired, and then the background task is triggered and performed, when it is determined that a condition for performing the background task is satisfied, based on the current performance parameter of the intelligent terminal, a performance parameter of the intelligent terminal is re-acquired after a preset time delay, when it is determined that a condition for performing the background task is not satisfied, based on the current performance parameter of the intelligent terminal. And it is determined whether to satisfy the condition for performing the background task, based on the re-acquired performance parameter of the intelligent terminal, the background task is triggered to perform when it is satisfied, thereby solving the phenomenon of stagnation, even crash of the intelligent terminal caused by running of the background task, and meanwhile guaranteeing to judge again after a preset time delay, when the current performance parameter cannot satisfy the condition for performing the background task, and the background task is smoothly performed when the performing condition is satisfied.

On the basis of the above technical solutions, prompt information also can be displayed, when it is determined that a condition for performing the background task is not satisfied, based on the current performance parameter of the intelligent terminal, the prompt information includes: whether to perform compulsorily for selection by the user, when the current performance parameter doesn't satisfy the condition for performing the background task, if the user selects to perform compulsorily, then the intelligent terminal can trigger to compulsorily perform the background task.

### Embodiment 3

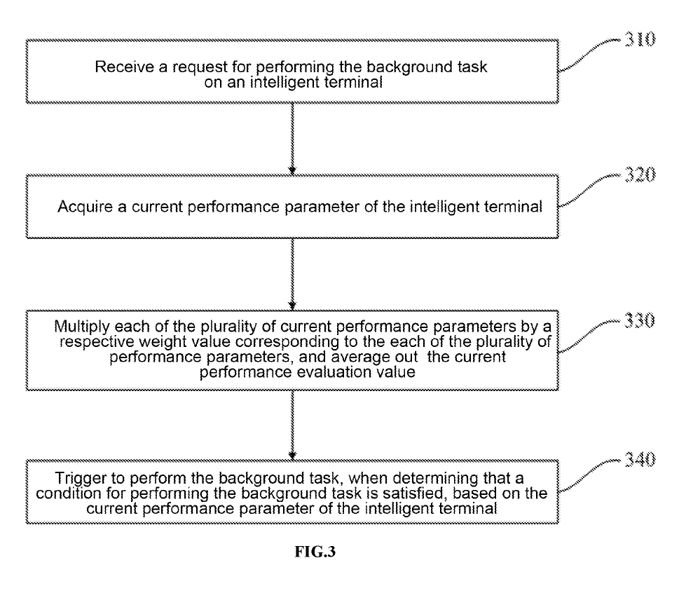

FIG. 3 is a schematic flowchart of a method for triggering a background task according to Embodiment 3 of this application, this embodiment is applicable to a case that the background task is performed in an intelligent terminal, and the method can be performed by an intelligent terminal, for example, an apparatus for triggering the background task installed on a smart phone, a tablet computer, and can include the following steps of:

Step 310, receiving a request for performing a background task on an intelligent terminal;

Step 320, acquiring a current performance parameter of the intelligent terminal;

Step 330, acquiring a current performance evaluation value of the intelligent terminal, based on the current performance parameter of the intelligent terminal, and determining that the condition for performing the background task is satisfied, based on the current performance evaluation value of the intelligent terminal.

Optionally, a plurality of current performance parameters of the intelligent terminal can be acquired in step 320, then in this step, the current performance evaluation value is obtained by multiplying each of the plurality of current performance parameters by a respective weight value corresponding to the each of the plurality of performance parameters, and then averaging. Particularly, in terms of different background tasks, each of the current performance parameters may play different functions, and the weight values of different performance parameters can be adjusted dynamically, for example, a downloading task of a starting-up video on a smartphone has a higher requirement on the network bandwidth, then the weight value of the network bandwidth can be set to be higher, and the weight values of the other performance parameters can be set to be lower correspondingly.

Step 340, triggering to perform the background task, when determining that a condition for performing the background task is satisfied.

By adopting the technical solution in Embodiment 3 of this application, the current performance evaluation value is obtained by multiplying each of the plurality of current performance parameters by a respective weight value corresponding to the performance parameters, and then averaging, and the performance evaluation value can dynamically match features of background tasks to make the evaluation result more targeted.

### Embodiment 4

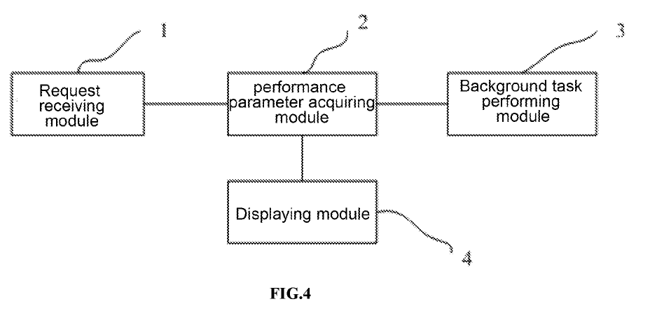

FIG. 4 is a schematic diagram showing a structure of an apparatus for triggering a background task according to Embodiment 4 of this application, and the apparatus includes:

a request receiving module 1, configured to receive a request for performing a background task on an intelligent terminal;

a performance parameter acquiring module 2, configured to acquire a current performance parameter of the intelligent terminal; and

a background task performing module 3, configured to trigger to perform the background task, when determining that a condition for performing the background task is satisfied, based on the current performance parameter of the intelligent terminal.

By adopting the technical solution in Embodiment 5 of this application, when the intelligent terminal is ready to perform the background task, firstly, the current performance parameter of the intelligent terminal is acquired, and then the background task is triggered and performed when it is determined that the current state of the intelligent terminal can satisfy the condition for performing the background task, based on the current performance parameter, thereby solving the phenomenon of stagnation, even crash of the intelligent terminal caused by running of the background task, and guaranteeing smooth running of functions of front end when the terminal equipment performs the background task.

Optionally, in the embodiments of this application, the request receiving module 1 is also configured to receive a request for performing a background task on an intelligent terminal, transmitted by a server end; or receive a request for performing the background task regularly triggered by an application software on an intelligent terminal; or receive a request for performing the background task on an intelligent terminal, initiated by a user.

Optionally, the background task performing module 3 is also configured to acquire a current performance evaluation value of the intelligent terminal, based on the current performance parameter of the intelligent terminal, and determines that the condition for performing the background task is satisfied, based on the current performance evaluation value of the intelligent terminal. Besides, the performance parameter acquiring module 2 also can be configured to acquire a plurality of current performance parameters of the intelligent terminal, the background task performing module 3 is also configured to multiply each of the plurality of current performance parameters by a respective weight value corresponding to the each of the plurality of performance parameters, and average out the current performance evaluation value; or determine a respective performance evaluation level of each of the plurality of current performance parameters, based on the plurality of current performance parameters, wherein, each performance evaluation level corresponds to one performance level value, and a sum of performance level values corresponding to the plurality of current performance parameters is used as the current performance evaluation value.

Optionally, the performance parameter comprises: at least one of a CPU load, a memory occupation rate, the current charge, the current charging type and a network bandwidth parameter.

Optionally, the performance parameter acquiring module 2 also can be configured to re-acquire a performance parameter of the intelligent terminal after a preset time delay, when determining that a condition for performing the background task is not satisfied, based on the current performance parameter of the intelligent terminal, and the performance parameter acquiring module 2 also can be configured to determine whether to satisfy the condition for performing the background task, based on the re-acquired performance parameter of the intelligent terminal.

The above apparatus for triggering a background task also can include a displaying module 4, configured to display prompt information, when determining that a condition for performing the background task is not satisfied, based on the current performance parameter of the intelligent terminal, wherein the prompt information comprises: whether to perform compulsorily, when the current performance parameter doesn't satisfy the condition for performing the background task.

In the embodiments of this application, the background task performing module 3 is also configured to acquire the condition for performing the background task, after receiving the request for performing the background task on the intelligent terminal.

The above apparatus for triggering the background task can perform the method provided in any of the embodiments of this application, and have corresponding function modules and beneficial effects.

### Embodiment 5

In Embodiment 1 of this application, it has been introduced that a performance evaluation level of the current performance parameter is determined, respectively, based on the plurality of current performance parameters, wherein, each performance evaluation level corresponds to one performance level value, and the sum of performance level values corresponding to the plurality of current performance parameters is taken as the current performance evaluation value, the evaluation criterion may be based on the following two tables, Table 1 is a correspondence table between a performance parameter and a performance evaluation level, and Table 2 is a correspondence table between a performance evaluation level and a performance level value.

TABLE 1

| Level | Good | Medium | Poor |
|---|---|---|---|
| CPU load | Below 5% | Below 10% | Below 20% |
| Current charge | Above 90% | Above 50% | Above 30% |
| Current | Power | Computer | Charging-free |
| charging type | charging | charging | state |
| Network | Wifi network | Mobile | Network-free |
| bandwidth | connection | network | connection |
| parameter | | connection | |

TABLE 2

| Level | Good | Medium | Poor |
|---|---|---|---|
| CPU load | 3 points | 2 points | 1 point |
| Current charge | 3 points | 2 points | 1 point |
| Current | 3 points | 2 points | 1 point |
| charging type | | | |
| Network | 3 points | 2 points | 1 point |
| bandwidth | | | |
| parameter | | | |

As shown in Table 1 and Table 2, the selected performance parameter in this embodiment includes a CPU load, the current charge, the current charging type and a network bandwidth parameter, wherein, each performance parameter is divided into three performance evaluation levels of good, medium and poor, and scoring criteria of the performance level values corresponding to the three performance evaluation levels are 3 points, 2 points and 1 point. In the CPU load parameter, the CPU load below 5% is defined to be level good and corresponds to 3 points; the CPU load below 10% (above 5%) is defined to be level medium and corresponds to 2 points; the CPU load below 20% (above 10%) is defined to be level poor and corresponds to 1 point. In the current charge parameter, the charge above 90% is defined to be level good, the charge above 50% and below 90% is defined to be level medium, and the charge above 30% and below 50% is defined to be level poor. In the current charging type parameter, using power charging corresponds to level good, using computer charging corresponds to level medium and a charging-free state corresponds to level poor. In the network performance parameter, wife network connection corresponds to level good, mobile network connection corresponds to level medium and a network-free connection corresponds to level poor.

In the technical solution provided in Embodiment 5 of this application, a performance evaluation level of the current performance parameter is determined, respectively, based on the plurality of current performance parameters, wherein, each performance evaluation level corresponds to one performance level value, and a sum of performance level values corresponding to the plurality of current performance parameters is taken as the current performance evaluation value, for example, when applied to a smartphone, it can be set to trigger to download a background task of a starting-up video, when the sum of multiple performance level values is greater than 10 points, wherein, 10 points can be considered as a performance evaluation threshold of a background task of downloading a starting-up video, and is used as a condition for performing the background task of downloading the starting-up video.

### Embodiment 6

Embodiment 6 of this application provides a non-transitory computer storage medium storing computer executable instructions for performing any of the above-described methods for triggering a background task according to any of the method embodiments.

### Embodiment 7

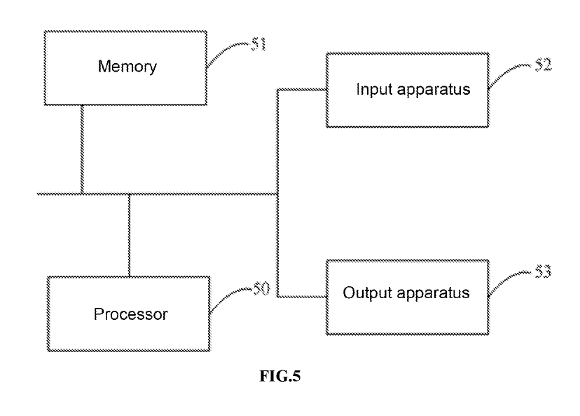

FIG. 5 is a schematic diagram showing the structure of hardware of an electronic device for performing a method for triggering the background task according to Embodiment 7 of this application, with reference to FIG. 5, the electronic device includes:

one or more processors 50 and a memory 51, in FIG. 5, one processor 50 is taken as an example;

The electronic device also can include: an input apparatus 52 and an output apparatus 53. The processor 50, the memory 51, the input apparatus 52 and the output apparatus 53 in the electronic device can be connected via a bus or by other means, in FIG. 5, the connection via a bus is taken as an example.

The memory 51, as a non-volatile computer-readable storage medium, can be used to store a non-volatile software program, a non-volatile computer-executable program and module, such as the program instruction/module corresponding to the method for triggering a background task according to embodiments of this application (for example, the request receiving module 1, the performance parameter acquiring module 2 and the background task performing module 3 as shown in FIG. 4). The processor 50 can perform functional applications and data processing in the server by running the software program, instruction and module stored in the memory 51, that is, the method for triggering the background task according to the above method embodiment can be implemented.

The memory 51 can include a storage program area and a storage data area, particularly, the storage program area can store an operating system and an application program required by at least one function; the storage data area can store data created by use of the terminal equipment. Besides, the memory 51 can include a high-speed random access memory, and also a non-volatile memory, such as at least one magnetic disk storage device, flash memory device or other non-volatile solid state storage device. In some examples, the memory 51 can include memories remotely located from the processor 50, these remote memories can connect to an intelligent terminal through the network. Examples of the above network include, but are not limited to, the Internet, an intranet, a local area network, a mobile communication network, and any combination thereof.

The input apparatus 52 can be configured to receive the input figure or character information, generate key signal input associated with the user setting and functional control of the terminal. The output apparatus 53 can include a display device, such as a display screen.

One or more modules are stored in the above memory 51, when one or more processors 50 are executed, steps of the method for triggering the background task according to any of the method embodiments are performed.

The above product can perform the method provided in the embodiments of this application, and have corresponding function modules and beneficial effects. It can be referred to the method provided in embodiments of this application for technical details, which are not described in detail in this embodiment.

The electronic device in the embodiments of this application can be found in many forms, including but not limited to:

1) a mobile communication device: such a device is featured by a mobile communication function and mainly directed to providing voice and data communication. This type of terminal includes: a smartphone (such as, IPHONE), a multimedia phone, a feature phone, a low-end phone, and etc.

2) a ultra-mobile personal computer device: such a device belongs to the category of personal computer, has a calculating and processing function, and generally has a mobile network access feature. This type of terminal includes: PDA, MID, UMPC device, and etc., such as IPAD.

3) a portable entertainment device: such a device can display and play multimedia contents. This type of device includes: an audio/video player (such as, IPOD), a hand-held gaming machine, an electronic book, an intelligent toy and a portable in-vehicle navigation device.

4) a server: a device for providing a computer service, the server is constructed of a processor, a hardware, a memory, a system bus, and etc., the server is similar to a general-purpose computer architecture, but has higher requirements on processing capability, stability, reliability, security, expandability and manageability, due to the requirement of providing highly reliable service.

5) other electronic apparatus having a data interaction function.

The embodiment of the device are exemplary only, the units described as separated parts can be or cannot be physically separated, and the parts shown as units can be or cannot be physical units, that is, the parts can be located in a place or distributed in multiple network units. Part or all of the modules of the device can be selected to achieve the purposes of the proposal of the embodiment according to the actual demand. Through the description of the above embodiments, persons skilled in the art can clearly know that, various embodiments can be realized by virtue of software plus general-purpose hardware platforms and by virtue of hardware. Based on such understanding, the parts which substantially contribute to the related art of the technical proposal can be embodied in the form of a computer software product, which can be stored in computer-readable storage media such as an ROM/RAM, a disk, an CD, etc., and includes multiple instructions to instruct computer equipment (which can be a personal computer, a server, network equipment, or the like) to execute each embodiment or the method described by some parts of the embodiment.

Finally, it should be noted that the above embodiments are merely provided for describing the technical solutions of this application, but not intended to limit this application. It should be understood by persons skilled in the art that although this application has been described in detail with reference to the foregoing embodiments, modifications can be made to the technical solutions described in the foregoing embodiments, or equivalent replacements can be made to some technical features in the technical solutions; however, such modifications or replacements do not cause the essence of corresponding technical solutions to depart from the scope of the embodiments of this application.

What is claimed is:

1. A method for triggering a background task, applied to a terminal, and comprising:
receiving a request for performing the background task on an intelligent terminal;
acquiring a current performance parameter of the intelligent terminal; and
triggering to perform the background task, when determining that a condition for performing the background task is satisfied, based on the current performance parameter of the intelligent terminal.

2. The method for triggering the background task according to claim 1, wherein, the determining that a condition for performing the background task is satisfied, based on the current performance parameter of the intelligent terminal, comprises:
acquiring a current performance evaluation value of the intelligent terminal, based on the current performance parameter of the intelligent terminal, and determining that the condition for performing the background task is satisfied, based on the current performance evaluation value of the intelligent terminal.

3. The method for triggering the background task according to claim 2, wherein, when a plurality of current performance parameters of the intelligent terminal are acquired, the acquiring the current performance evaluation value of the intelligent terminal, based on the current performance parameter of the intelligent terminal, comprises:
multiplying each of the plurality of current performance parameters by a respective weight value corresponding to the each of the plurality of performance parameters, and averaging out the current performance evaluation value.

4. The method for triggering the background task according to claim 2, wherein, when a plurality of current performance parameters of the intelligent terminal are acquired, the acquiring the current performance evaluation value of the intelligent terminal, based on the current performance parameter of the intelligent terminal, comprises:
determining a respective performance evaluation level of each of the plurality of current performance parameters, based on the plurality of current performance parameters, wherein each performance evaluation level corresponds to one performance level value, and a sum of performance level values corresponding to the plurality of current performance parameters is taken as the current performance evaluation value.

5. The method for triggering the background task according to claim 1, wherein, the performance parameter comprises: at least one of a CPU load, a memory occupation rate, the current charge, the current charging type and a network bandwidth parameter.

6. The method for triggering the background task according to claim 1, further comprising:
re-acquiring a performance parameter of the intelligent terminal after a preset time delay, when determining that a condition for performing the background task is not satisfied, based on the current performance parameter of the intelligent terminal, and determining whether to satisfy the condition for performing the background task, based on the re-acquired performance parameter of the intelligent terminal.

7. The method for triggering the background task according to claim 1, further comprising:
displaying prompt information, when determining that a condition for performing the background task is not satisfied, based on the current performance parameter of the intelligent terminal, wherein the prompt information comprises: whether to perform compulsorily, when the current performance parameter doesn't satisfy the condition for performing the background task.

8. The method for triggering the background task according to claim 1, wherein, the receiving a request for performing the background task on the intelligent terminal, comprises:
receiving the request for performing the background task on the intelligent terminal, transmitted by a server end; or
receiving the request for performing the background task regularly triggered by an application software on the intelligent terminal; or
receiving the request for performing the background task on the intelligent terminal, initiated by a user.

9. The method for triggering the background task according to claim 1, wherein, after receiving the request for performing the background task on the intelligent terminal, the method further comprises:
acquiring a condition for performing the background task.

10. A non-transitory computer storage medium storing computer executable instructions, when executed by an electronic device, causes the electronic device to perform the following operations of:
receiving a request for performing the background task on an intelligent terminal;
acquiring a current performance parameter of the intelligent terminal; and
triggering to perform the background task, when determining that a condition for performing the background task is satisfied, based on the current performance parameter of the intelligent terminal.

11. The non-transitory computer storage medium according to claim 10, wherein, the determining that a condition for performing the background task is satisfied, based on the current performance parameter of the intelligent terminal, comprises:
acquiring a current performance evaluation value of the intelligent terminal, based on the current performance parameter of the intelligent terminal, and determining that the condition for performing the background task is satisfied, based on the current performance evaluation value of the intelligent terminal.

12. An electronic device, comprising:
at least one processor, and
a memory communicably connected with the at least one processor and for storing instructions executable by the at least one processor,
wherein execution of the instructions by the at least one processor causes the at least one processor to perform the following operations of:
receiving a request for performing background task on an intelligent terminal;
acquiring a current performance parameter of the intelligent terminal; and
triggering to perform the background task, when determining that a condition for performing the background task is satisfied, based on the current performance parameter of the intelligent terminal.

13. The electronic device according to claim 12, wherein, the determining that a condition for performing the background task is satisfied, based on the current performance parameter of the intelligent terminal, comprises:
acquiring a current performance evaluation value of the intelligent terminal, based on the current performance parameter of the intelligent terminal, and determining that the condition for performing the background task is satisfied, based on the current performance evaluation value of the intelligent terminal.

14. The electronic device according to claim 13, wherein, when a plurality of current performance parameters of the intelligent terminal are acquired, the acquiring the current performance evaluation value of the intelligent terminal, based on the current performance parameter of the intelligent terminal, comprises:
multiplying each of the plurality of current performance parameters by a respective weight value corresponding to the each of the plurality of performance parameters, and averaging out the current performance evaluation value.

15. The electronic device according to claim 13, wherein, when a plurality of current performance parameters of the intelligent terminal are acquired, the acquiring the current performance evaluation value of the intelligent terminal, based on the current performance parameters of the intelligent terminal, comprises:
determining a respective performance evaluation level of each of the plurality of current performance parameters, based on the plurality of current performance parameters, wherein, each performance evaluation level corresponds to one performance level value, and a sum of performance level values corresponding to the plurality of current performance parameters is taken as the current performance evaluation value.

16. The electronic device according to claim 12, wherein, the performance parameter comprises: at least one of a CPU load, a memory occupation rate, the current charge, the current charging type and a network bandwidth parameter.

17. The electronic device according to claim 12, further causing the at least one processor to perform the following operations of:
re-acquiring a performance parameter of the intelligent terminal after a preset time delay, when determining that a condition for performing the background task is not satisfied, based on the current performance parameter of the intelligent terminal, and determining whether to satisfy the condition for performing the background task, based on the re-acquired performance parameter of the intelligent terminal.

18. The electronic device according to claim 12, further causing the at least one processor to perform the following operations of:
displaying prompt information, when determining that a condition for performing the background task is not satisfied, based on the current performance parameter of the intelligent terminal, wherein the prompt information comprises: whether to perform compulsorily, when the current performance parameter doesn't satisfy the condition for performing the background task.

19. The electronic device according to claim 12, wherein, the receiving a request for performing the background task on the intelligent terminal, comprises:
receiving the request for performing the background task on the intelligent terminal, transmitted by a server end; or
receiving the request for performing the background task regularly triggered by an application software on the intelligent terminal; or
receiving the request for performing the background task on the intelligent terminal, initiated by a user.

20. The electronic device according to claim 12, wherein, after receiving the request for performing the background task on the intelligent terminal, the electronic device further causes the at least one processor to perform the following operation of:
acquiring a condition for performing the background task.
